(19) United States
(12) Patent Application Publication
(10) Pub. No.: US 2025/0190852 A1
(43) Pub. Date: Jun. 12, 2025

(54) FEDERATED LEARNING MODEL ATTACK PREVENTION

(71) Applicant: Dell Products L.P., Round Rock, TX (US)

(72) Inventors: Ramesh DODDAIAH, Westborough, MA (US); Daniel L. HAMLIN, Round Rock, TX (US); Malathi RAMAKRISHNAN, Madurai (IN); Vivekanandh Narayanasamy RAJAGOPALAN, Bangalore (IN)

(73) Assignee: Dell Products L.P., Round Rock, TX (US)

(21) Appl. No.: 18/535,868

(22) Filed: Dec. 11, 2023

(51) Int. Cl. G06N 20/00

(52) U.S. Cl. CPC G06N 20/00

(57) ABSTRACT

An information handling system may include at least one processor and a memory. The information handling system may be configured to: receive data during each of a plurality of time windows, wherein the data is associated with a machine learning model; determine that particular data from a particular time window is associated with a statistical anomaly; and in response to the determining, prevent the particular data from the particular time window from being used to update the machine learning model.

### TECHNICAL FIELD

The present disclosure relates in general to information handling systems, and more particularly to detecting malicious data and preventing the malicious data from being used to train a machine learning model.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Hyper-converged infrastructure (HCI) is an IT framework that combines storage, computing, and networking into a single system in an effort to reduce data center complexity and increase scalability. Hyper-converged platforms may include a hypervisor for virtualized computing, software-defined storage, and virtualized networking, and they typically run on standard, off-the-shelf servers. One type of HCI solution is the Dell EMC VxRail™ system. Some examples of HCI systems may operate in various environments (e.g., an HCI management system such as the VMware® vSphere® ESXi™ environment, or any other HCI management system). Some examples of HCI systems may operate as software-defined storage (SDS) cluster systems (e.g., an SDS cluster system such as the VMware® vSAN™ system, or any other SDS cluster system).

In the HCI context (as well as other contexts), information handling systems may execute virtual machines (VMs) for various purposes. A VM may generally comprise any program of executable instructions, or aggregation of programs of executable instructions, configured to execute a guest operating system on a hypervisor or host operating system in order to act through or in connection with the hypervisor/host operating system to manage and/or control the allocation and usage of hardware resources such as memory, central processing unit time, disk space, and input and output devices, and provide an interface between such hardware resources and application programs hosted by the guest operating system.

HCI systems (and other systems) may be used to train models as discussed herein. For example, embodiments of this disclosure may be relevant to the situation of using a group of information handling systems to train a federated machine learning (ML) model or other artificial intelligence (AI) model. For example, one or more cloud systems may be used to build an ML model, while edge compute endpoints (e.g., sensors, smartphones, etc.) may collect data locally to build a local model (e.g., local to the edge gateway or server associated with those edge compute endpoints). The actual data collected by the edge devices may or may not be sent to the cloud system, but updates to the local models based on that collected data are typically propagated periodically to the central model in the cloud system via edge gateways or edge servers.

Problems may arise, however, if edge devices are infected with malware or otherwise compromised. In such cases, it would be desirable to be able to detect malicious data before it is incorporated into the central model.

Some embodiments of this disclosure may employ AI techniques such as ML, deep learning, etc. Generally speaking, ML encompasses a k branch of data science that emphasizes methods for enabling information handling systems to construct analytic models that use algorithms that learn interactively from data. It is noted that, although disclosed subject matter may be illustrated and/or described in the context of a particular AI paradigm, such a system, method, architecture, or application is not limited to those particular techniques and may encompass one or more other AI solutions.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with training of federated learning models may be reduced or eliminated.

In accordance with embodiments of the present disclosure, an information handling system may include at least one processor and a memory. The information handling system may be configured to: receive data during each of a plurality of time windows, wherein the data is associated with a machine learning model; determine that particular data from a particular time window is associated with a statistical anomaly; and in response to the determining, prevent the particular data from the particular time window from being used to update the machine learning model.

In accordance with these and other embodiments of the present disclosure, a method may include an information handling system receiving data during each of a plurality of time windows, wherein the data is associated with a machine learning model; the information handling system determining that the data from a particular time window is associated with a statistical anomaly; and in response to the determining, the information handling system preventing the data from the particular time window from being used to update the machine learning model.

In accordance with these and other embodiments of the present disclosure, an article of manufacture may include a non-transitory, computer-readable medium having computer-executable instructions thereon that are executable by a processor of an information handling system for: receiving data during each of a plurality of time windows, wherein the data is associated with a machine learning model; determining that the data from a particular time window is associated with a statistical anomaly; and in response to the determining, preventing the data from the particular time window from being used to update the machine learning model.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates a block diagram of an example architecture, in accordance with embodiments of the present disclosure;

FIG. 3 illustrates examples of I/O anomalies, in accordance with embodiments of the present disclosure; and

FIG. 4 illustrates a flow chart of a method, in accordance with embodiments of the present disclosure.

### DETAILED DESCRIPTION

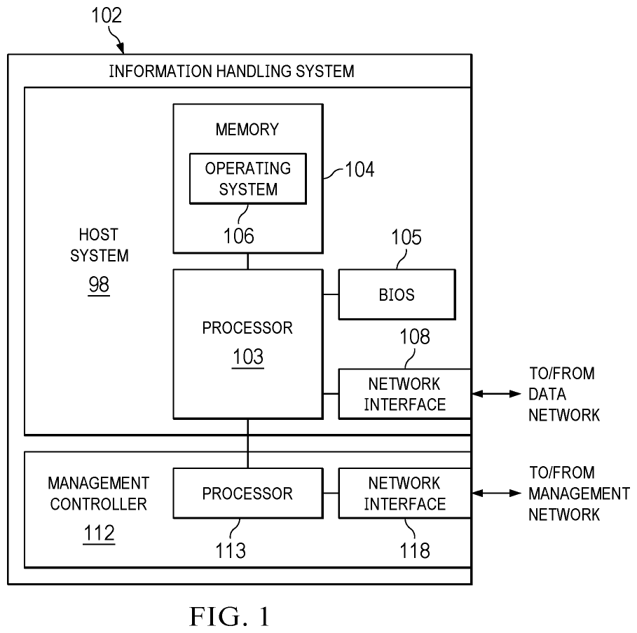

Preferred embodiments and their advantages are best understood by reference to FIGS. 1 through 4, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality f servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, or device operable to serve as an interface apparatus, between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, a group of information handling systems 102 (e.g., including edge compute nodes, edge gateways, and a central cloud system) may be used to train a federated ML model. Embodiments of this disclosure are relevant to the situation of an edge device being compromised by malware, ransomware, a virus, or the like. Such a compromised edge device may attempt to influence or corrupt the central model in the cloud system. Embodiments of this disclosure may prevent such an attack from succeeding.

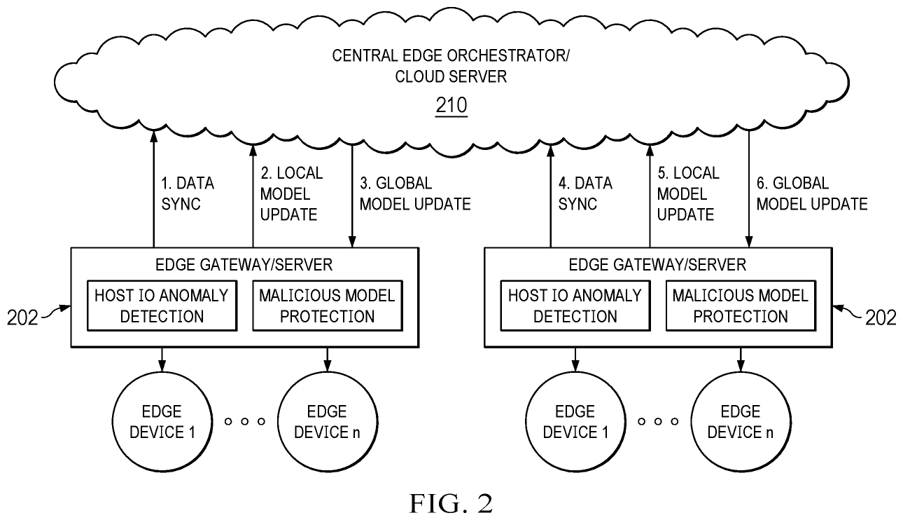

FIG. 2 shows an embodiment in which edge gateways 202 may each manage several edge compute endpoints across different geographical locations. Data collected on the edge gateways 202 may be analyzed locally to train a local model, and elements from that trained local model may be shared across the ecosystem as part of the federated learning process. The aggregated edge data may be synced to the central cloud server 210 periodically, which may train a centralized model based thereon.

A ransomware attack at an edge gateway 202 (or an edge device coupled thereto) may propagate to the cloud server 210, eventually affecting all the edge devices. Existing anomaly detection algorithms are available, but they do not consider the problem of data consistency. As part of the federated learning process, the malicious model at the edge will eventually be shared to other edge gateways 202 through the cloud server 210.

Embodiments thus provide a method to automatically create instant snapshots to protect data from malware attacks at the edge, and they may be used to stop the local and/or central model learning process when anomalies are detected. Within a given time window T (e.g., 10 minutes), if an anomaly detection algorithm finds anomalous activity (e.g., anomalous write I/O) at a given edge gateway 202, then all dependent writes based on that I/O may be stopped before the central model at cloud server 210 is affected.

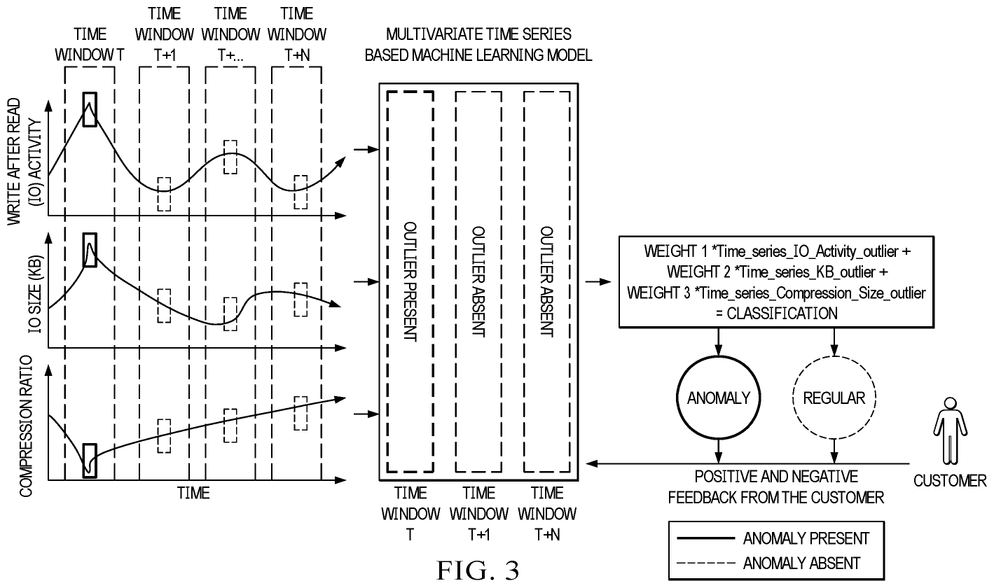

FIG. 3 provides an example of the operation of a snapshot architecture in a time series machine learning anomaly detection model, according to some embodiments. As shown, the anomaly detection classification model may be based on a weighted sum of various parameters (e.g., I/O activity, I/O size, I/O compression ratio, etc.).

If an anomaly is detected during time window T, then local instant read-only snapshots of the data and the local model may be taken at the edge gateway to prevent ransomware attacks from propagating upstream. As shown, any of various I/O characteristics such as I/O size, amount of activity, compression ratio, etc. may be considered to detect device-level anomalies.

When an anomaly is detected, an administrator may be notified and the model may be prevented from learning based on the malicious data. The administrator may then recover the system to an earlier instant snapshot based on further analysis. As shown, the administrator may also provide feedback to the anomaly detection model to improve its accuracy and reduce false alarms in the future.

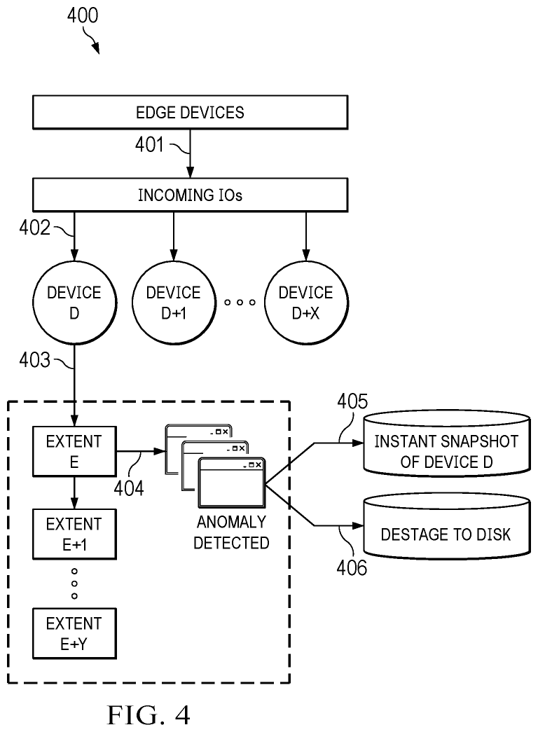

FIG. 4 illustrates a flowchart of an example method, according to some embodiments. In order to detect anomalies, at steps 401-403, a multivariate time series may be captured (e.g., per disk extent) to record data for several different figures of merit. For example, an I/O write/read detector may capture suspicious I/O activity such as write-after-read patterns. An I/O size detector may capture patterns in the I/O sizes. A compression ratio detector may capture the I/O compressibility patterns. Outliers in these and other parameters may be indicative of a compromised edge node.

At step 404, each time series may then be split into sliding windows, where each time window is of a selected length (e.g., 10 minutes). Within each time window, statistical outliers may be analyzed. For example, a time window may be flagged as an outlier if the new I/O sizes are drastically different compared to historical analysis, or if corresponding anomalies are detected in the other time series.

Data may be destaged from volatile memory to non-volatile memory at step 406 only at the end of a given time window. This provides a 10 minute window to detect an anomaly and act on it by preventing destaging.

If an anomaly is detected at step 405, then the system may prevent the suspect data from being destaged and take a snapshot of the good data as it exists prior to the affected time window.

Each time series may be weighted, and an aggregated time window classification may be used to determine if the new writes on a device are outliers. The snapshot process may take an instant (backward in time as of the beginning of the time window) local snapshot of data and the local model as soon as it detects an anomaly, and it may avoid rebuilding the local model from malicious data to prevent the malicious model from propagating to the cloud system and to other edge gateways.

An administrator may also manually inspect the system to determine if it is providing false positives or false negatives, providing feedback to the model to improve it further. If the administrator thinks the anomaly is genuine, then the production data may be restored with the automatically backed up instant snapshots, mitigating the attack.

One of ordinary skill in the art with the benefit of this disclosure will understand that the preferred initialization points for the method depicted in FIG. 4 and the order of the steps comprising the method may depend on the implementation chosen. In these and other embodiments, the method may be implemented as hardware, firmware, software, applications, functions, libraries, or other instructions. Further, although FIG. 4 discloses a particular number of steps to be taken with respect to the disclosed method, the method may be executed with greater or fewer steps than depicted. The method may be implemented using any of the various components disclosed herein (such as the components of FIG. 1), and/or any other system operable to implement the methods.

This disclosure encompasses all changes, substitutions, variations, alterations, and modifications to the exemplary embodiments herein that a person having ordinary skill in the art would comprehend. Similarly, where appropriate, the appended claims all encompass changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor; and
a memory;
wherein the information handling system is configured to:
receive data during each of a plurality of time windows, wherein the data is associated with a machine learning model;
determine that particular data from a particular time window is associated with a statistical anomaly; and
in response to the determining, prevent the particular data from the particular time window from being used to update the machine learning model.

2. The information handling system of claim 1, wherein the information handling system is a hyper-converged infrastructure (HCI) system.

3. The information handling system of claim 2, wherein the data is received from at least one edge node of the HCI system.

4. The information handling system of claim 1, wherein the machine learning model is a federated learning model.

5. The information handling system of claim 4, wherein preventing the data from the particular time window from being used to update the machine learning model comprises:
preventing the particular data from being used to update a local model; and
preventing the particular data from being sent to a cloud system that is configured to build a central model.

6. The information handling system of claim 1, wherein the statistical anomaly is associated with at least one of a write-after-read activity anomaly, a data size anomaly, and a compression ratio anomaly.

7. A method comprising:
an information handling system receiving data during each of a plurality of time windows, wherein the data is associated with a machine learning model;
the information handling system determining that the data from a particular time window is associated with a statistical anomaly; and
in response to the determining, the information handling system preventing the data from the particular time window from being used to update the machine learning model.

8. The method of claim 7, wherein the information handling system is a hyper-converged infrastructure (HCI) system.

9. The method of claim 8, wherein the data is received from at least one edge node of the HCI system.

10. The method of claim 7, wherein the machine learning model is a federated learning model.

11. The method of claim 10, wherein preventing the data from the particular time window from being used to update the machine learning model comprises:
preventing the particular data from being used to update a local model; and
preventing the particular data from being sent to a cloud system that is configured to build a central model.

12. The method of claim 7, wherein the statistical anomaly is associated with at least one of a write-after-read activity anomaly, a data size anomaly, and a compression ratio anomaly.

13. An article of manufacture comprising a non-transitory, computer-readable medium having computer-executable instructions thereon that are executable by a processor of an information handling system for:
receiving data during each of a plurality of time windows, wherein the data is associated with a machine learning model;
determining that the data from a particular time window is associated with a statistical anomaly; and
in response to the determining, preventing the data from the particular time window from being used to update the machine learning model.

14. The article of claim 13, wherein the information handling system is a hyper-converged infrastructure (HCI) system.

15. The article of claim 14, wherein the data is received from at least one edge node of the HCI system.

16. The article of claim 13, wherein the machine learning model is a federated learning model.

17. The article of claim 16, wherein preventing the data from the particular time window from being used to update the machine learning model comprises:
preventing the particular data from being used to update a local model; and
preventing the particular data from being sent to a cloud system that is configured to build a central model.

18. The article of claim 13, wherein the statistical anomaly is associated with at least one of a write-after-read activity anomaly, a data size anomaly, and a compression ratio anomaly.
